(19) United States
(12) Patent Application Publication
(10) Pub. No.: US 2015/0300831 A1
(43) Pub. Date: Oct. 22, 2015

(54) Emotion Based Travel Guide System and Method

(71) Applicant: AppTripper s.r.l., Sulmona (IT)

(72) Inventor: Raffaello Sernicola, Napoli (IT)

(21) Appl. No.: 14/688,930

(22) Filed: Apr. 16, 2015

Related U.S. Application Data
(60) Provisional application No. 61/981,622, filed on Apr. 18, 2014.

(51) Int. Cl. G01C 21/34; G01C 21/36

(52) U.S. Cl. CPC G01C 21/3476; G01C 21/3667

(57) ABSTRACT

Emotion based travel guide systems and methods are provided herein. In one embodiment a method includes receiving at least a user emotion and a user location from a user, constructing an emotion-based tour plan using the user emotion and the user location, where the user location includes points of interest that are each associated with a description that is capable of being assigned a point of interest emotion, The points of interest are found proximate the user location and matched to the user emotion by matching the point of interest emotion for the points of interest. The method also includes providing the emotion-based tour plan to the user via a client device.

### CROSS REFERENCE TO RELATED APPLICATIONS

This application claims the priority benefit of U.S. Provisional Patent Application Ser. No. 61/981,622, filed on Apr. 18, 2014, which is hereby incorporated herein by reference—including any references, attachments, and appendices cited therein.

### FIELD OF THE INVENTION

The present technology pertains to travel related services, and more specifically, but not by way of limitation, to methods and systems that provide electronically (e.g., application driven) guided art-related or entertainment-related tours, based upon the emotions of the individual partaking in the tour. The present technology allows an individual to self-guide through a city, museum, entertainment park, music event, or other location, discovering places, objects, monuments, and other aesthetic or entertaining points of interest, which match the emotion of the individual.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method, including: receiving at least a user emotion and a user location from a user; constructing an emotion-based tour plan using the user emotion and the user location, where the user location includes points of interest that are each associated with a description that is capable of being assigned an point of interest emotion, the points of interest being found proximate the user location and matched to the user emotion by matching the point of interest emotion for the points of interest; and providing the emotion-based tour plan to the user via a client device. Other embodiments of this aspect include corresponding computer systems, apparatus, and computer programs recorded on one or more computer storage devices, each configured to perform the actions of the methods.

One general aspect includes a method, for generating a plurality of pre-defined emotion-based tour plans, the method including: creating a plurality of points of interest, where the plurality of points of interest include an emotion and a location. The method also includes assembling the plurality of points of interest into the plurality of pre-defined emotion-based tour plans according to an emotion shared between the plurality of points of interest; and selecting one or more of the plurality of pre-defined emotion-based tour plans for a user based on a user emotion determined for the user. Other embodiments of this aspect include corresponding computer systems, apparatus, and computer programs recorded on one or more computer storage devices, each configured to perform the actions of the methods.

One general aspect includes a method for providing a graphical user interface for displaying an emotion-based tour plan, the method including: determining a user location of a user; selecting a user emotion for a user from an analysis of user behaviors and user data related to social networks, client device data, and web browsing for the user; constructing an emotion-based tour plan using the user emotion and the user location, where the user location includes points of interest that are each associated with a description that is capable of being assigned a point of interest emotion, the points of interest being found proximate the user location and matched to the user emotion by matching the point of interest emotion for the points of interest; and generating a graphical user interface that includes a visual representation of the emotion-based tour plan; and providing the graphical user interface to a client device of the user. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an exemplary computing architecture that can be used to practice aspects of the present technology.

FIG. 2 illustrates an exemplary computing system that may be used to implement embodiments according to the present technology.

FIG. 3 is an example graphical user interface (GUI) in the form of a location selection dashboard.

FIG. 4 is an example graphical user interface (GUI) in the form of a user emotion selection dashboard.

FIG. 5 is an example graphical user interface (GUI) that allows a user to select features such as music, emotion-based travel plans (e.g., itineraries), social networking, and so forth.

FIG. 6 is an example graphical user interface (GUI) that comprises an emotion wheel where a user can select a user emotion.

FIG. 7 is an example graphical user interface (GUI) that comprises a user emotion, point of interest data, and media matrix.

FIG. 8 is an example graphical user interface (GUI) that includes detailed information regarding a point of interest.

FIG. 9 is an example graphical user interface (GUI) that includes an image of a point of interest.

FIG. 10 is an example graphical user interface (GUI) that includes an example map comprising an emotion based tour plan that follows an emotion route.

FIG. 11 is an example graphical user interface (GUI) that includes both emotion based points of interest and non-emotion based points of interest.

FIG. 12 is an example graphical user interface (GUI) that includes an emotional thermometer representation for a user.

FIG. 13 is an example graphical user interface (GUI) that includes an emotion selection bar and user feed.

FIG. 14 is an example graphical user interface (GUI) that includes a mechanism for recording audio feedback regarding a point of interest.

FIG. 15 is an example graphical user interface (GUI) that includes a landing page that allows a user to select an emotion based guided tour or a game related to an emotion based guided tour.

FIG. 16 is an example graphical user interface (GUI) that includes a user emotion and a map comprising points of interest related that selected emotion.

FIG. 17 is an example graphical user interface (GUI) that includes an example quiz question.

FIG. 18 is an example graphical user interface (GUI) that includes an example selection of unlockable games and emotion based tour plans.

FIG. 19 is an example graphical user interface (GUI) that includes a list of example emotion based tour games.

FIGS. 20-27 each illustrate example games that are created regarding points of interest, which are selected from an emotion based tour plan or a user emotion.

FIG. 28 is an example flowchart of a method for providing an emotion based tour plan via a graphical user interface.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

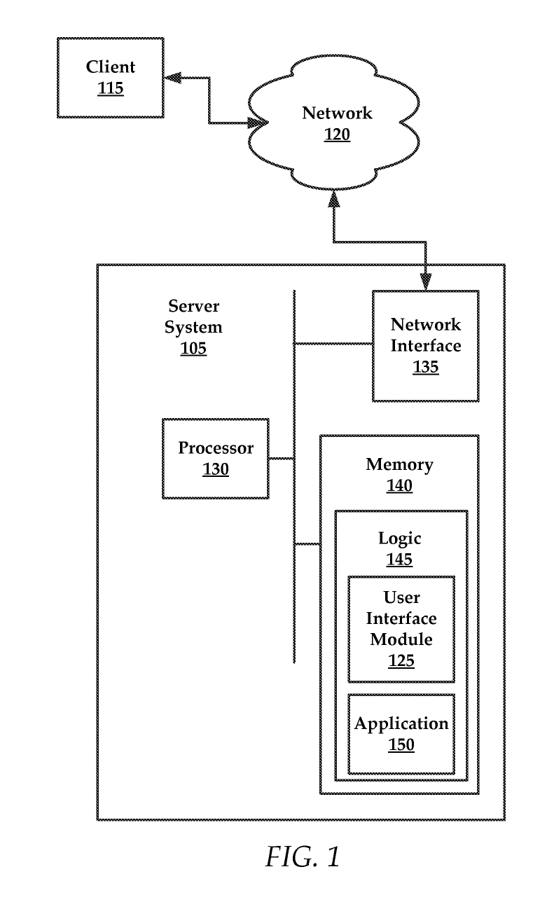

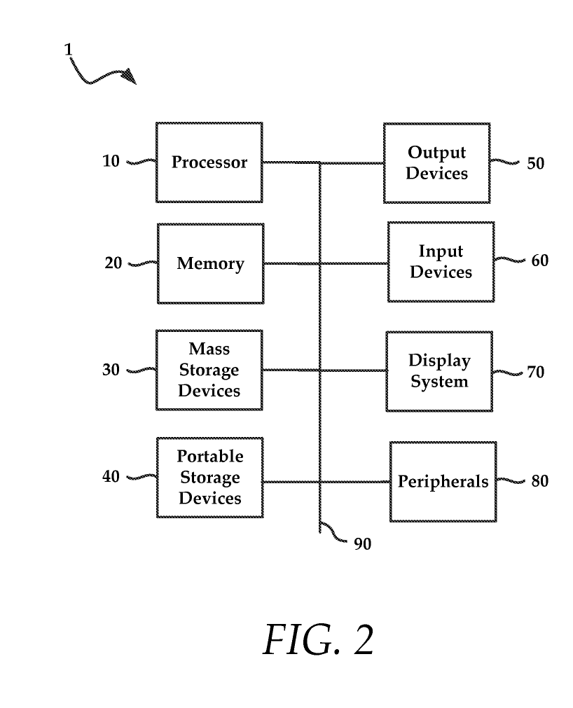

FIG. 1 illustrates an exemplary architecture for practicing aspects of the present technology. The architecture comprises a server system, hereinafter “system 105” that is configured to provide various functionalities, which are described in greater detail throughout this document. Generally the system 105 is configured to communicate with client devices, such as client 115. The client 115 may include, for example, a Smartphone, a laptop, a computer, or other similar computing device. An example of a computing device that can be utilized in accordance with the present technology is described in greater detail with respect to FIG. 2.

The system 105 may communicatively couple with the client 115 via a public or private network, such as network 120. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The system 105 generally comprises a processor, 130, a network interface 135, and a memory 140. According to some embodiments, the memory 140 comprises logic (e.g., instructions) 145 that can be executed by the processor 130 to perform various methods. For example, the logic may include a user interface module 125 as well as a data aggregation and correlation application (hereinafter application 150) that is configured to provide the functionalities described in greater detail herein.

It will be understood that the functionalities described herein, which are attributed to the system 105 and application 150 may also be executed within the client 115. That is, the client 115 may be programmed to execute the functionalities described herein. In other instances, the system 105 and client 115 may cooperate to provide the functionalities described herein, such that the client 115 is provided with a client-side application that interacts with the system 105 such that the system 105 and client 115 operate in a client/server relationship. Complex computational features may be executed by the server 105, while simple operations that require fewer computational resources may be executed by the client 115, such as data gathering and data display.

In general, the user interface module 125 may be executed by the system 105 to provide various graphical user interfaces (GUIs) that allow users to interact with the system 105. In some instances, GUIs are generated by execution of the application 150 itself. Users may interact with the system 105 using, for example, a client 115. The system 105 may generate web-based interfaces for the client.

Generally, the present technology encompasses an application-based electronic tour guide hereinafter referred to as a “guide”. The application provides a plurality of graphical user interfaces (GUIs) that allow a tourist/user to interact with, and use features of the application.

Broadly speaking, the application 150 provides emotion based maps or tour plans that guide a tourist on an emotion-based tour of various points of interest. The application 150 can be executed within the context of a computing architecture, such as the architecture of FIG. 1, described in greater detail below. The application can be executed locally on a user device (e.g., client 115), such as a Smartphone or tablet device. Alternatively, the application can be accessed by a user device over a network. Thus, the application 150 can be executed on a server and accessed by the user device using a browser application. The server will serve GUIs of the application 150 as web pages of a standard or mobile website.

According to some embodiments, the application 150 is configured to create a profile of an individual, referred to herein as a “tourist”. The application 150 is further configured to allow the tourist to select a user emotion that closely fits the emotional state of the tourist. The tourist can also select a user emotion in a more objective manner. For example, even if the tourist is in a somber mood the tourist may desire to view places or art that are upbeat in theme. Examples of emotions include, but are not limited to ecstasy, surprise, joy, melancholy, wonder, love, fear, and anger. Other emotions can also be likewise utilized in accordance with the present technology.

The application 150 also tracks the location of the user device of the user. The application 150 can generate or select a suggested tour plan for the tourist based upon their respective location. Additionally, the application 150 can consider the mobility of the tourist when selecting and creating the tour plan. For example, the application 150 may not select destinations that are spaced too far apart from one another if the tourist is of limited mobility, such as if the tourist is traveling on foot or if the tourist has a physical disability that makes traveling more difficult.

In some embodiments, the application 150 allows a user to input user emotions when viewing or reviewing points of interest. For example, the user can indicate that a particular work of art elicits a melancholy emotion from the user. The user can review points of interest in terms of emotion in an ad hoc manner, meaning that the user can rate or review a point of interest at any time using the application 150, whether the user is on a guided tour or not.

The system 105 can obtain emotion-based reviews from a plurality of users over time to create a database of emotion-based points of interest. These emotion-based points of interest can be utilized to create emotion-based tour plans, as described in greater detail below.

In general, users can express their “like” differentiated by emotions for each piece of art presented on the application 150. By collecting users' “emotional likes” the system 105 will build an analytics data base both for users and art pieces (or other points of interest).

In some embodiments, the system 105 can obtain and correlate a user's behavior and/or personality profile with their user account. Aspects of behavior and personality profiling are beyond the scope of this disclosure but would be known to one of ordinary skill in the art. Examples include Meyers-Briggs and human metrics. The emotion-based reviews can be stored in combination with the user's personality profile.

The system 105 can tailor emotion-based tours to a user by determining their personality profile, receiving an emotion and location from the user, and matching points of interest based on the emotion, relative to other users with similar personalities. By way of example, a sanguine, outgoing personality profile may rate certain pieces of art work differently than a person with a melancholy personality profile. Thus, the system 105 can suggest points of interest by first matching the user with others having the same personality profiles, and secondly selecting points of interest using the specified emotion.

The application 150 may generate a tour plan on-the-fly, based on the location and user emotion of the traveler. For example, the tourist can select a user emotion and the application 150 will build the tour plan using extensive databases of destinations, objects, artwork, as well as other artistic points of interest that would be known to one of ordinary skill in the art. That is, prior to creating a tour plan, an extensive database(s) of points of interest are created. Each of the points of interest is associated with at least a point of interest emotion and a location. The location can be broad, such as a city, or may be more granular, such as a wall within an art gallery.

By way of example, a database of points of interest, such as artwork within an art gallery, such as the Uffizi gallery can be created. Descriptive information about each work of art within the gallery is known. Using this descriptive information, a point of interest emotion or emotions can be tagged to each piece of artwork in the gallery. Additionally, a location of each piece of artwork within the gallery is also known or is determined. This data can be used to create various emotion-based tour plans, as will be discussed in greater detail below.

The database may store pre-defined tour plans that are emotion-based. For example, a set of points of interest for an art gallery may be created using point of interest emotions determined for the various points of interest in the art gallery. A plurality of tour plans can be created if the gallery includes enough points of interest. In one embodiment an emotion-based tour plan may include a set of eight points of interest that are each tagged with the same emotion. Again, many of these tour plans may be generated for a single gallery.

When a tourist requests a tour plan (also referred to as an “emotional path”), the application 150 will request a user emotion from the tourist. Using this user emotion, the application 150 can construct one or more emotion-based tour plans. For example, the tourist may specify that they are in the mood to view somber themed artwork using the application 150 that is executed on a user device associated with the tourist. The application 150 will know the location of the tourist from location information obtained from their user device. The application 150 will query the database for a pre-defined tour plan. The tour plan can be displayed on the user device of the tourist. Again, rather than using a pre-defined tour plan the application 150 may generate a tour plan on-the-fly, or in real time.

The tour plan may include a map that illustrates an overview of the tour plan. The tour plan may also include, for each point of interest, a fact sheet or other descriptive information that instructs the tourist as to the details of each point of interest. As mentioned above, while the above examples have contemplated tour plans for an art gallery, it will be understood that tour plans can likewise be created for other locations, such as a city, a portion of a city, a university, or other locations that include points of interest that can be quantified or evaluated in terms of emotion. For example, a memorial in a city that commemorates a tragic event may be associated with an emotion of sorrow or somberness.

Additionally, the application 150 may include GUIs that provide the tourist with information about the various galleries in a city. The application 150 may provide social networking functions, allowing users to interact with one another, participate in guided tours together, send and receive messages, chat with other tourists, upload photographs, post reviews of artwork or other points of interest, and so forth.

In some embodiments, the application 150 allows the tourist to record verbal notes about a point of interest, such as a particular work of art. The tourist can post their commentary to a website, blog, or social network using the application 150. The application 150 will allow a tourist to see friends that are using the application and are in proximity to the tourist. The application 150 may map the location of these friends and display the same to the tourist.

In some instances, the application provides games or quizzes that are related to the points of interest in a tour plan. For example, the application 150 may provide a tourist with a quiz that asks the tourist to identify works of art that were found on their emotion-based tour.

According to some embodiments, the present technology is directed to a method for creating an emotion-based tour plan. The method preferably includes receiving at least a user emotion and a location from a user. The method also includes constructing an emotion-based tour plan using the user emotion and the location. As mentioned above, a location comprises points of interest that are each associated with a description that is capable of being assigned a point of interest emotion. The method may include selecting a set of points of interest for the location and assembling the points of interest into a tour plan. The tour plan is then provided for display to the user.

In some embodiments, the system 105 can utilize user emotion input as a basis for different application features and functionalities that will assist the system 105 in profiling users accordingly with their application usage and city/museums/entertainment events experiences for commercialization in various example ways.

As mentioned above, -users can express their “like” differentiated by emotions for each piece of art presented on the application. By collecting users' “emotional likes” the system 105 can build an analytics data base both for users and art pieces.

By collecting emotional the system 105 can illustrate an emotional meter for art pieces or for an aggregated set of art pieces cataloged by different metadata. For instance the system 105 can present the emotional status of a city museum, or of an entertainment event. This emotional status can be associated with one user or more than one user such that the emotional status is an aggregate emotional status.

The system 105 can present different items in the same application screen of an art piece (or of a city or of a museum or of an entertainment event) correlated with user emotional profile and usage. Examples of commercial endeavors include, but are not limited to, mobile ticketing for museums, art galleries, and so forth; purchases of video, media, audio, and the like; and targeted advertising.

In some embodiments, the system 105 can utilize emotion-based input and information on social networks to drive user participation and interest.

FIG. 2 illustrates an exemplary computing device 1 that may be used to implement an embodiment of the present systems and methods. The system 1 of FIG. 2 may be implemented in the contexts of the likes of the server 105 described herein. The computing device 1 of FIG. 2 includes a processor 10 and main memory 20. Main memory 20 stores, in part, instructions and data for execution by processor 10. Main memory 20 may store the executable code when in operation. The system 1 of FIG. 2 further includes a mass storage device 30, portable storage device 40, output devices 50, user input devices 60, a display system 70, and peripherals 80.

The components shown in FIG. 2 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 2. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 2 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device.

Peripherals 80 may include any type of computer support device to add additional functionality to the computing system. Peripherals 80 may include a modem or a router.

The components contained in the computing system 1 of FIG. 2 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

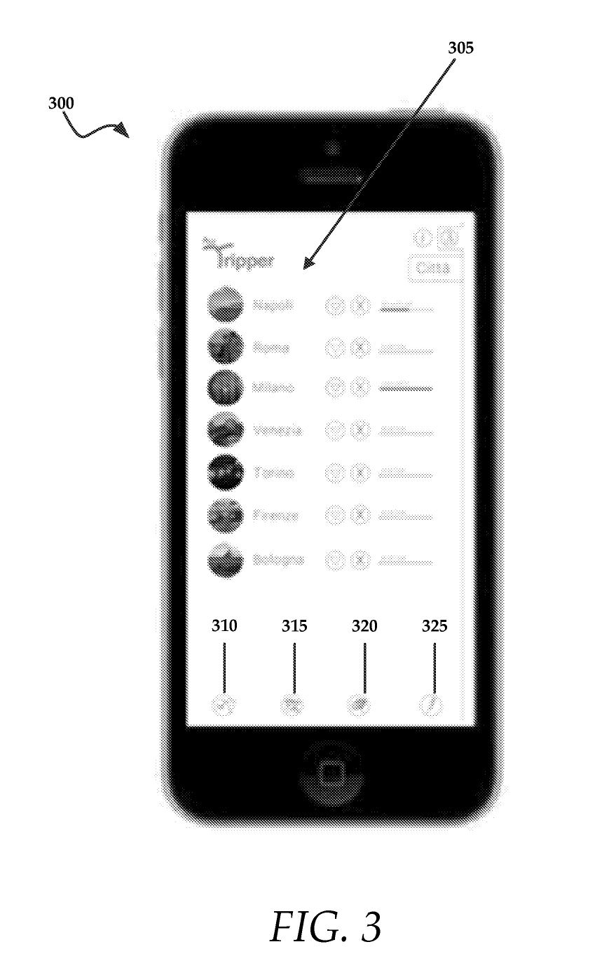

FIG. 3 illustrates an example graphical user interface (GUI) 300 that allows a user to select their user location. In other embodiments, the application can determine the user location through GPS coordinates or other location-based information available from the client device. In some embodiments, the GUI includes a list of available locations 305 where emotion-based tour plans are available. The locations 305 can each include one or more pre-determined emotion-based tour plans. Also, rather than pre-determined emotion-based tour plans, the locations 305 can each include at least points of interest that have point of interest emotion and a point of interest location.

Button 310 can be used to select social media features, while button 315 can be selected to provide a friend or contact list. Button 320 can be selected to provide notifications and push messages and button 325 can be selected to allow the user to record an audio message.

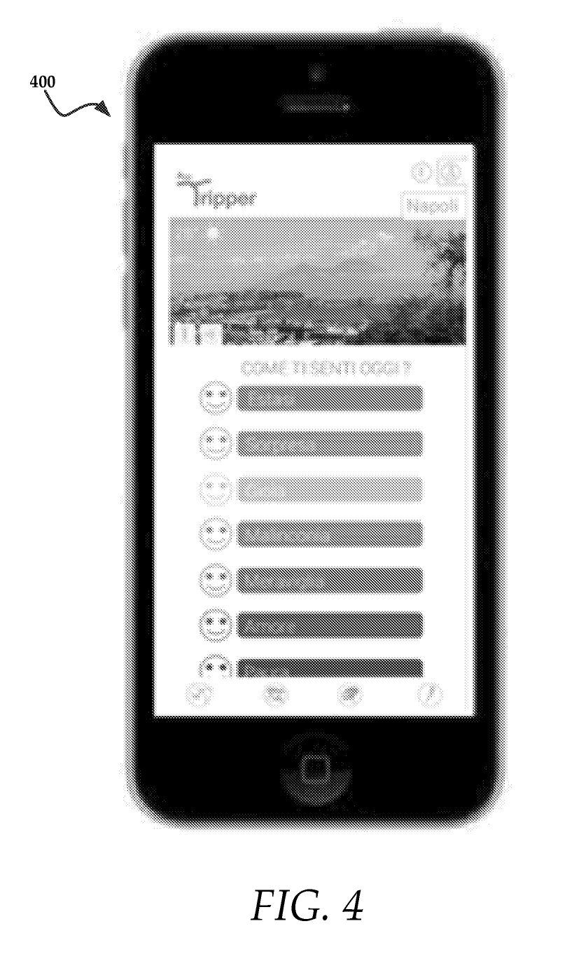

FIG. 4 illustrates an example graphical user interface (GUI) 400 that allows a user to select an emotion that is applied to a point of interest. For example, the user can select an emotion of “happy” to identify a city for which the user has very positive emotions. The point of interest emotion of “happy” can be tagged to the city and stored by the system 105, for example as a database record.

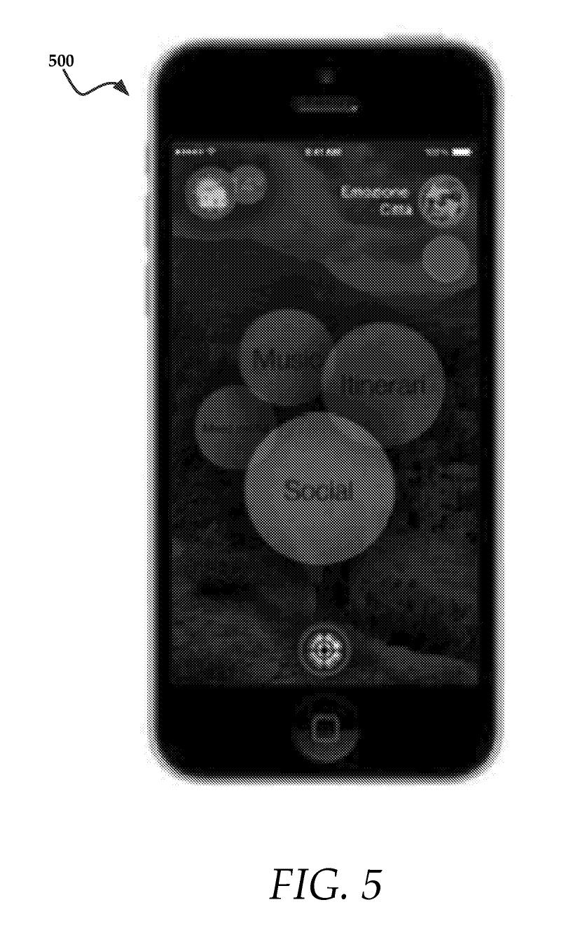

FIG. 5 illustrates an example graphical user interface (GUI) 500 that automatically displays a user emotion for the user. In some embodiments, the system can be configured to evaluate user data from social networks, client device data (such as phone records or messages), and web browsing behavior—just to name a few. The system can deduce a user emotion from their user behaviors/data. The user emotion can be displayed to the user along with other features such as social networking, music, tours, and multimedia emotions.

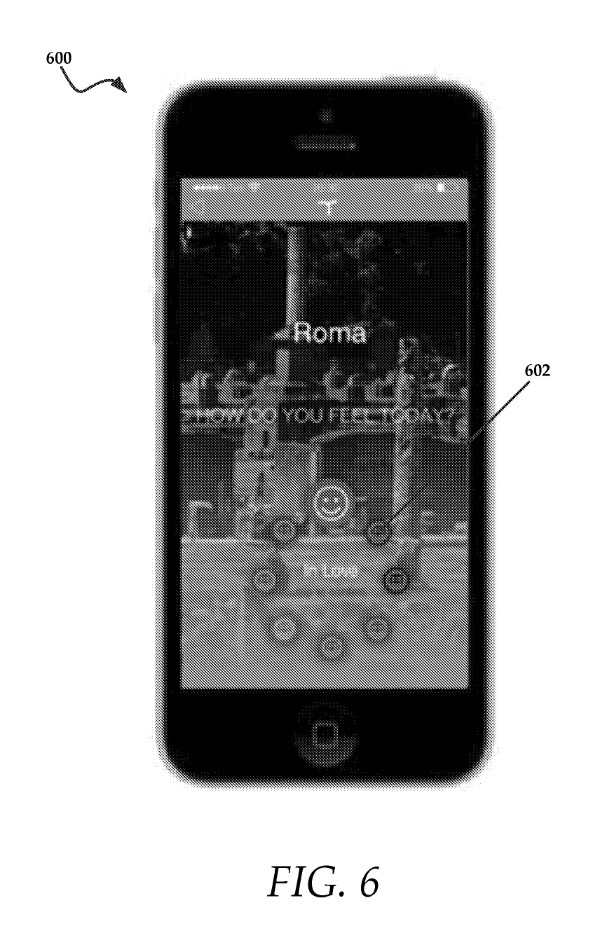

FIG. 6 is an example graphical user interface (GUI) 600 that allows a user to select a location and a user emotion through a wheel 602 of emotional states.

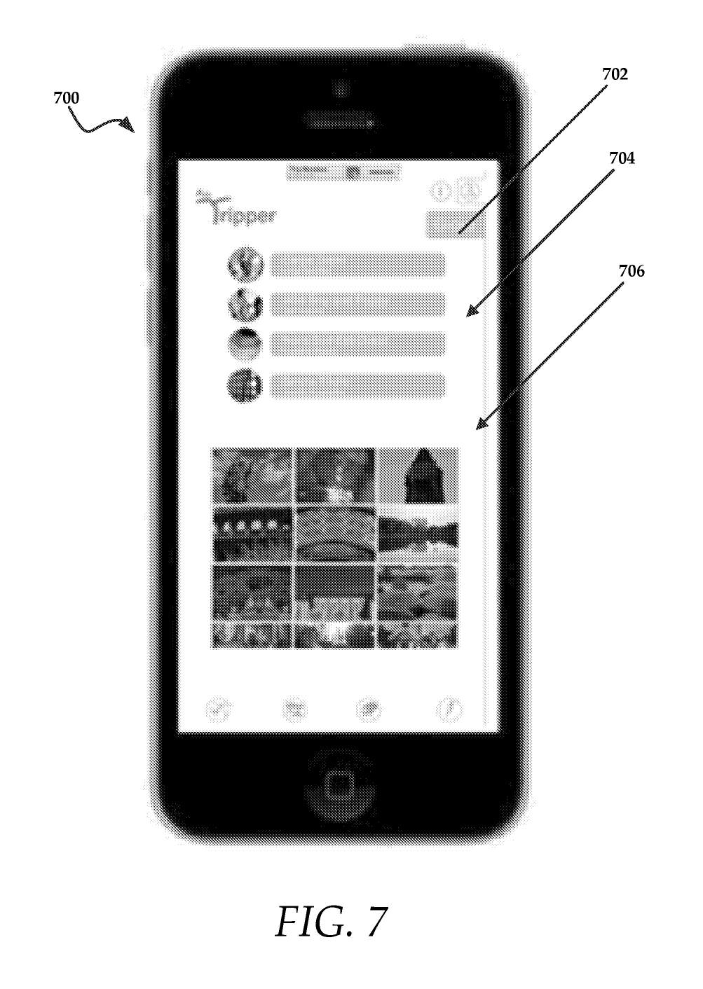

FIG. 7 is an example graphical user interface (GUI) 700 that is displayed after a user selects an emotion through GUI 600 (FIG. 6). The GUI 700 displays the selected user emotion 702 as well as provides a selection of points of interest 704, which in this embodiment includes artwork. A matrix 706 of multimedia objects is provided on the GUI 700 as well.

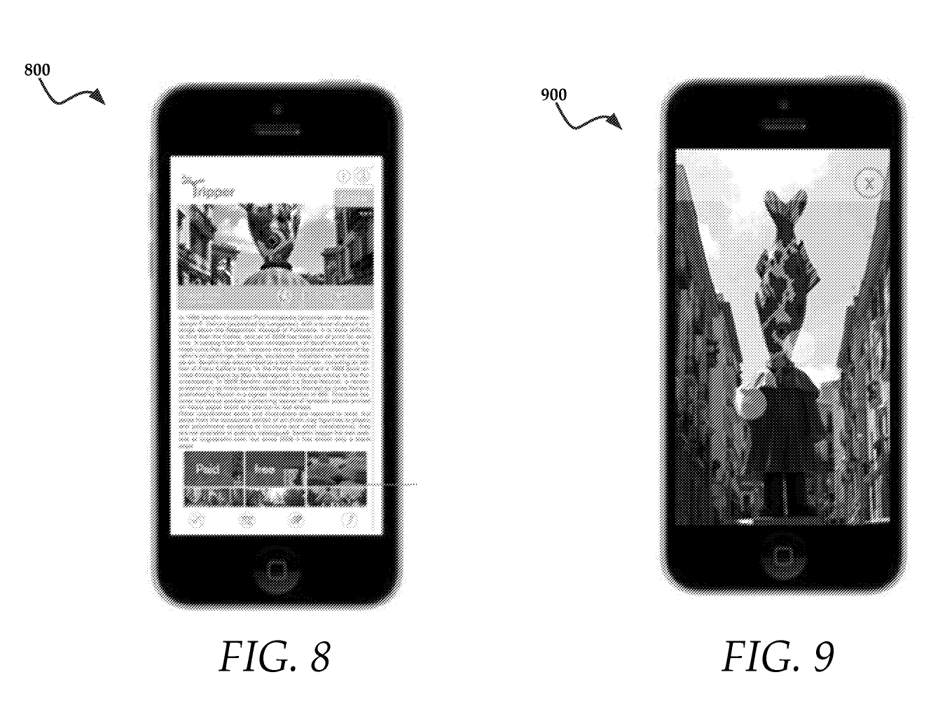

FIG. 8 is an example graphical user interface (GUI) 800 that provides an image of a point of interest, such as a sculpture. FIG. 9 is an example graphical user interface (GUI) 900 that provides a summary of information for a point of interest or location.

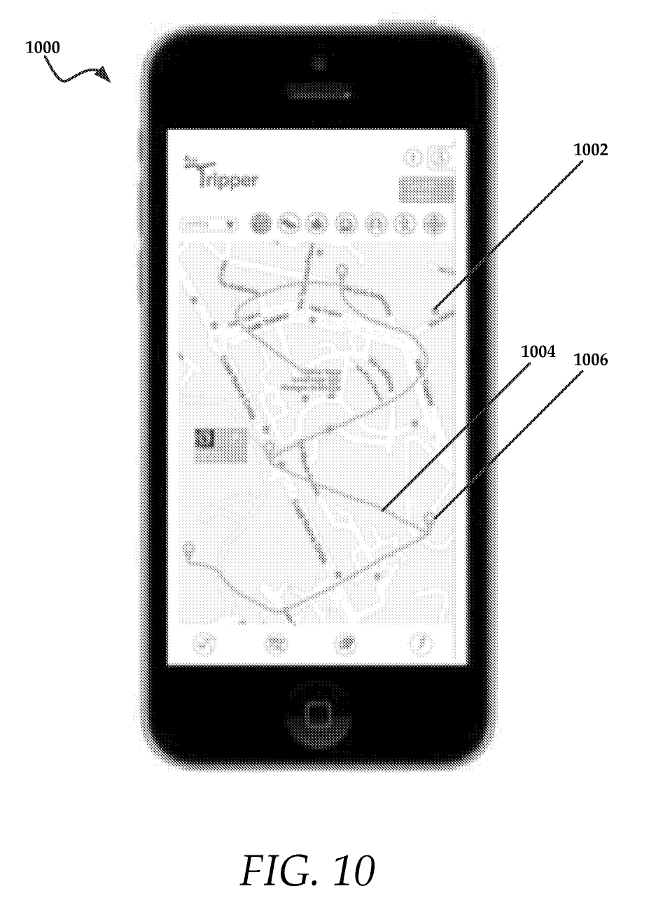

FIG. 10 is an example graphical user interface (GUI) 1000 that provides a map 1002. The map 1002 displays a path of emotion 1004 defined by points of interest, such as point of interest 1006. In some embodiments, points of interest can be assigned a color or hue that corresponds to an emotion. The map 1002 includes colored points or circles that are indicative of points of interest.

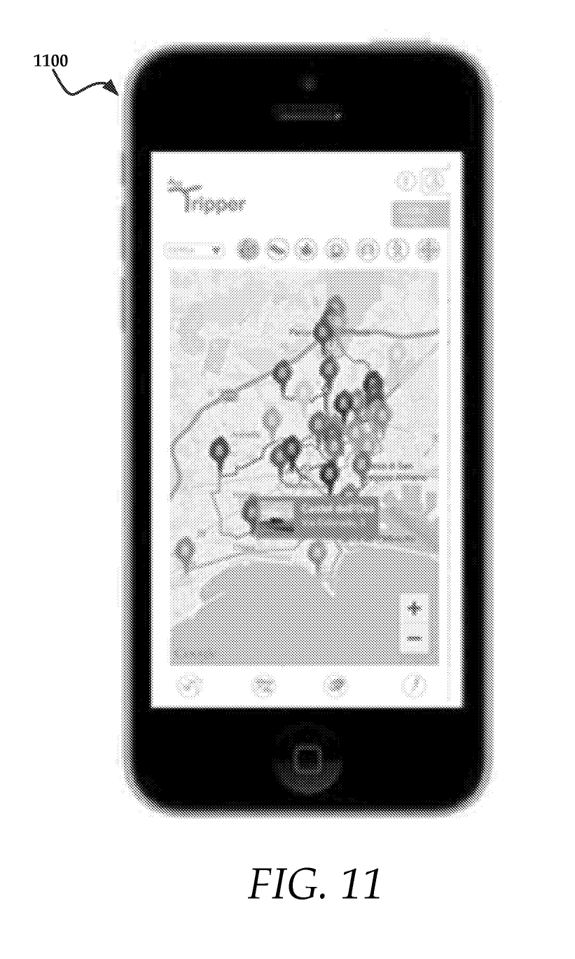

In some embodiments, additional points of interest such as restaurants and hotels can be layered onto the map as illustrated in FIG. 11. These non-emotion points of interest can be colored with a neutral color such as black or brown. The GUI can include directions between points of interest, GPS location selection, which allows the user to be pinpointed on the map 1002 (FIG. 10), as well as icons that represent other friends/contacts around the user.

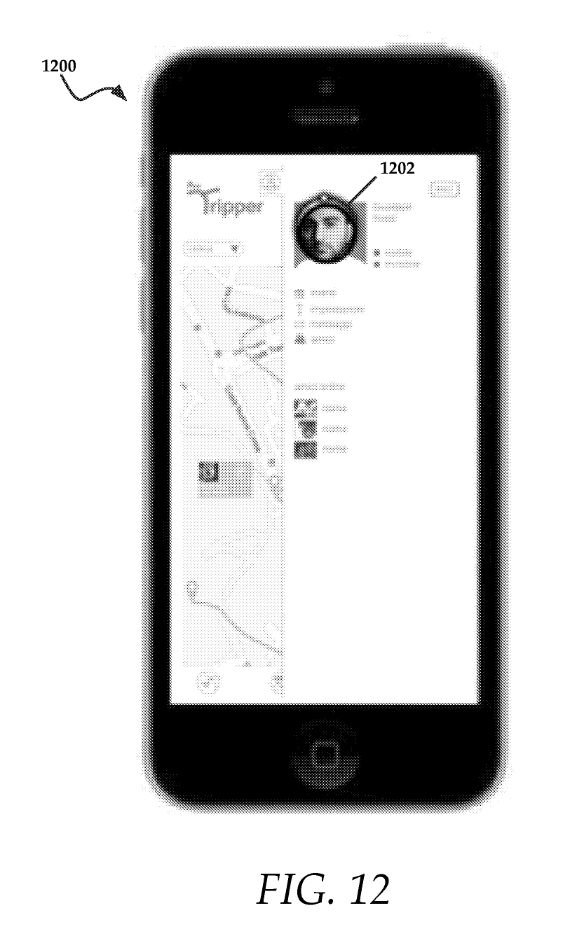

FIG. 12 is an example graphical user interface (GUI) 1200 that provides an emotional thermometer 1202 that indicates the selected or determined mood of the user. The emotional thermometer 1202 can be displayed in combination with an image of the user.

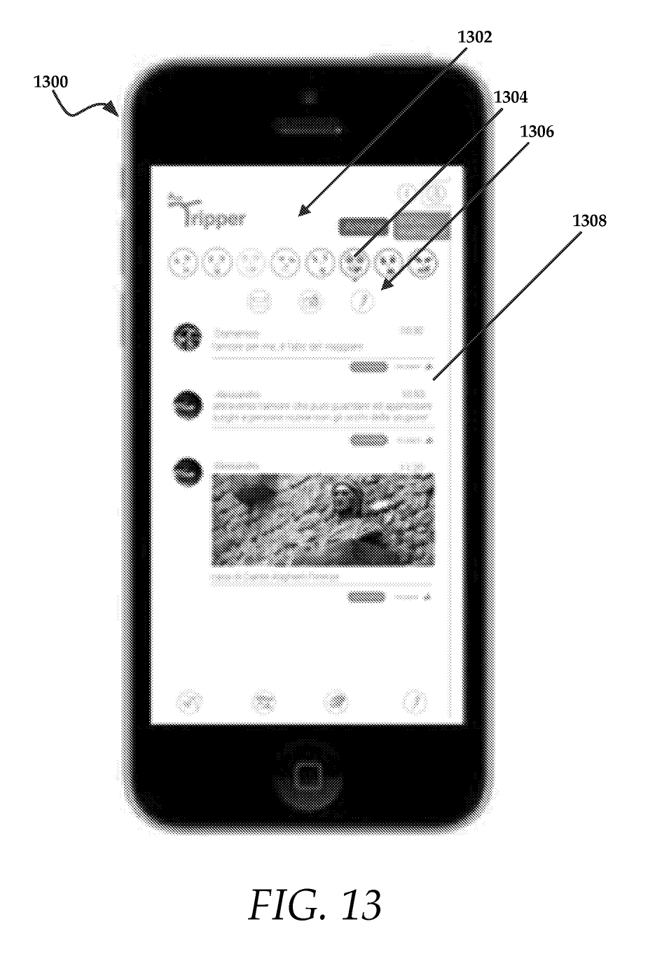

FIG. 13 is an example graphical user interface (GUI) 1300 that provides the user with a selected emotion bar 1302. The emotion bar 1302 comprises a plurality of emotions such as emotion 1304 that are selectable by the user. The user can also utilize controls 1306 to capture/post video, audio, ad/or image files. Textual information and posted files can be arranged into a feed 1308.

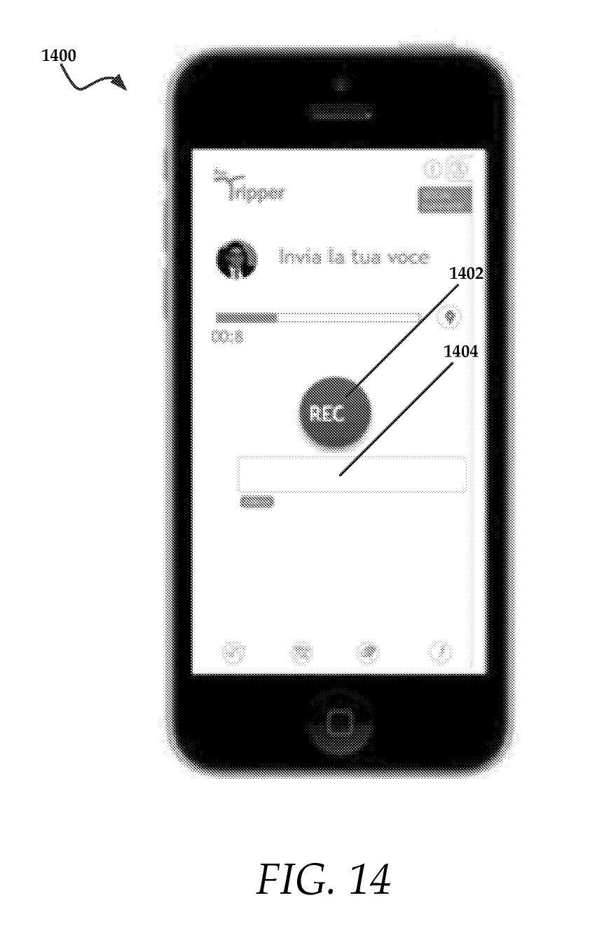

FIG. 14 is an example graphical user interface (GUI) 1400 that provides the user with the ability to record an audio message or other feedback that relates to a point of interest. The user can initiate recording of audio with button 1402. The user can also add annotations to the audio file using text box 1404.

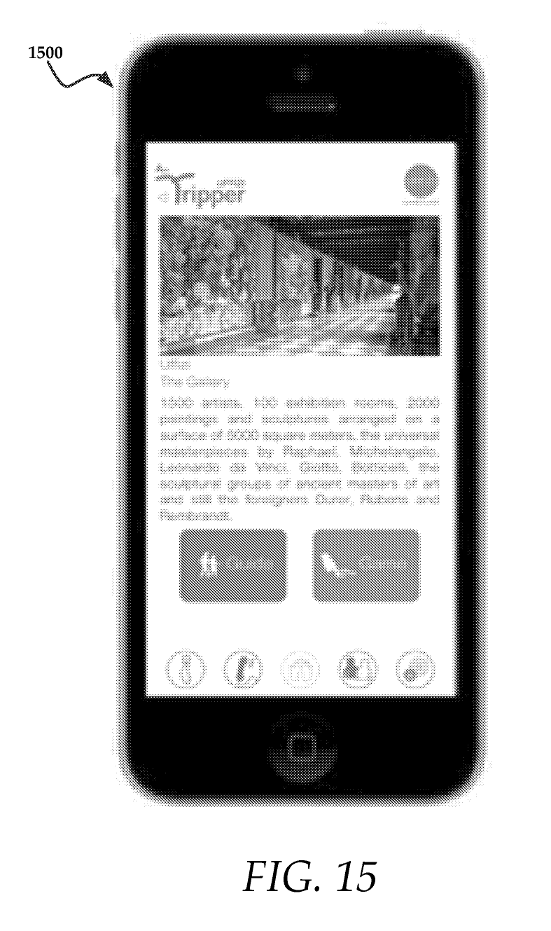

FIG. 15 is an example graphical user interface (GUI) 1500 that allows a user to select an emotion-based tour plan or a game related to an emotion-based tour plan.

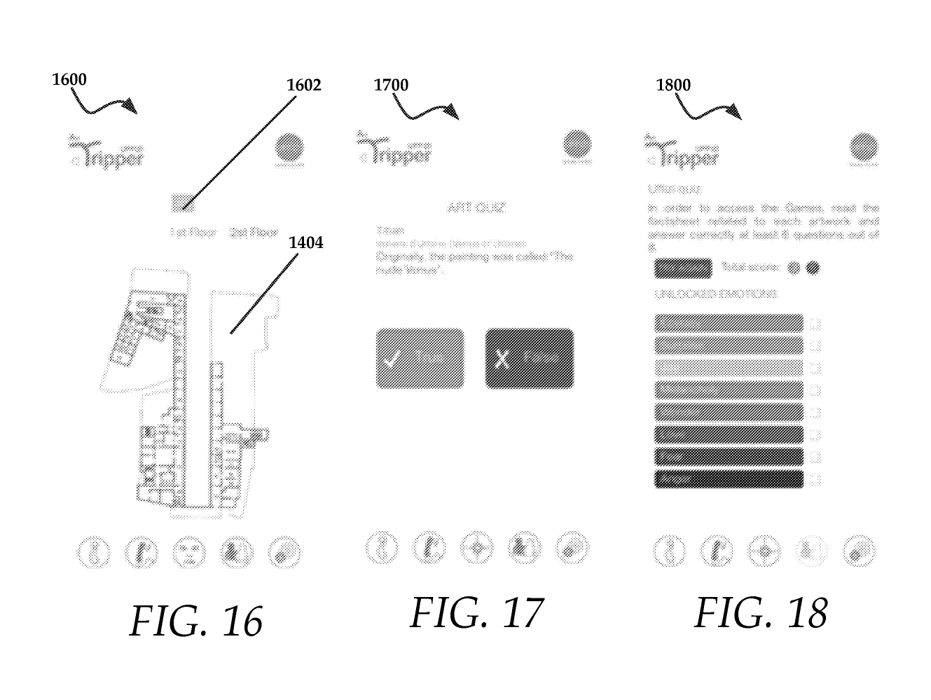

FIGS. 16-18 collectively illustrate an example quiz game related to an emotion-based tour plan. FIG. 16 is an example graphical user interface (GUI) 1600 that includes an emotion-based tour plan of an art gallery. An emotion icon 1602 is displayed alongside a map 1604.

FIG. 16 illustrates an example art quiz game 1700 where a user is quizzed about a point of interest included the emotion-based tour plan. The system can generate a question or set of question for one or more of the points of interest. In some embodiments, the user can “unlock” additional emotion-based tour plans associated with other emotions as illustrated in GUI 1800 of FIG. 18. For example, other emotions can include ecstasy, surprise, joy, melancholy, wonder, love, fear, anger, and so forth.

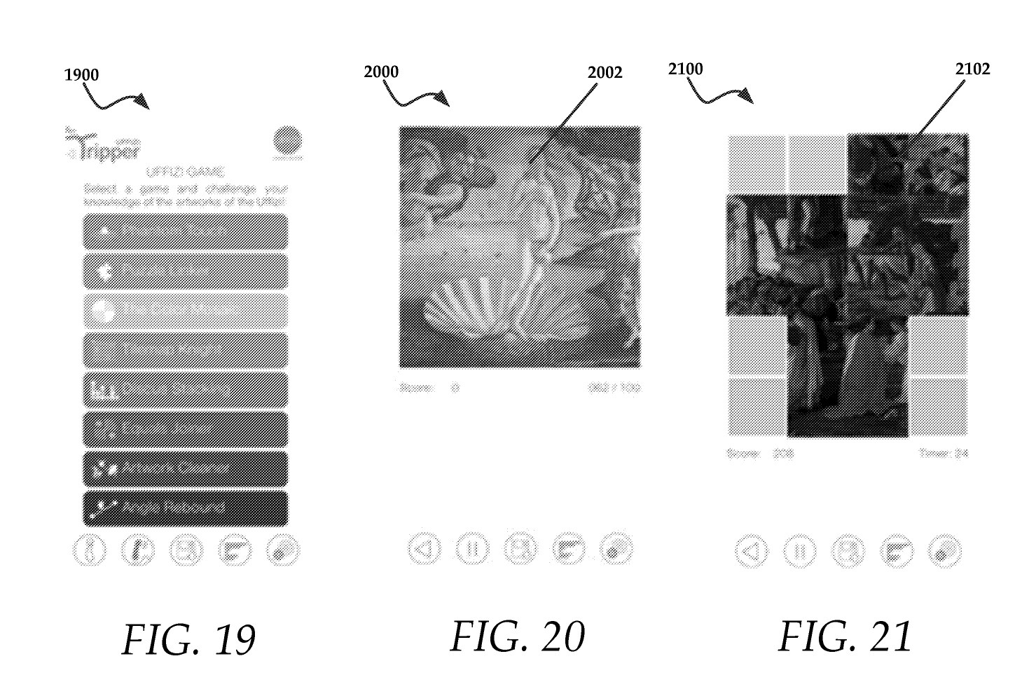

FIG. 19 is a GUI 1900 that comprises a list of games available to the user. FIG. 20 illustrates an example game 2000 referred to as a phantom touch. In this game, the user taps on a part of the artwork that becomes colored, such as part 2002, before the time expires. The faster the user is, the higher points the user will obtain. If the user hits an uncolored area a counter stops. The user wins if the user exceeds the quota indicated at the bottom right.

In FIG. 21, an example game 2100, referred to as the puzzle linker is illustrated. In this game the user moves pieces within the provided area 2102 and interlocks them in order to produce a complete picture. The user will lose if the timer expires.

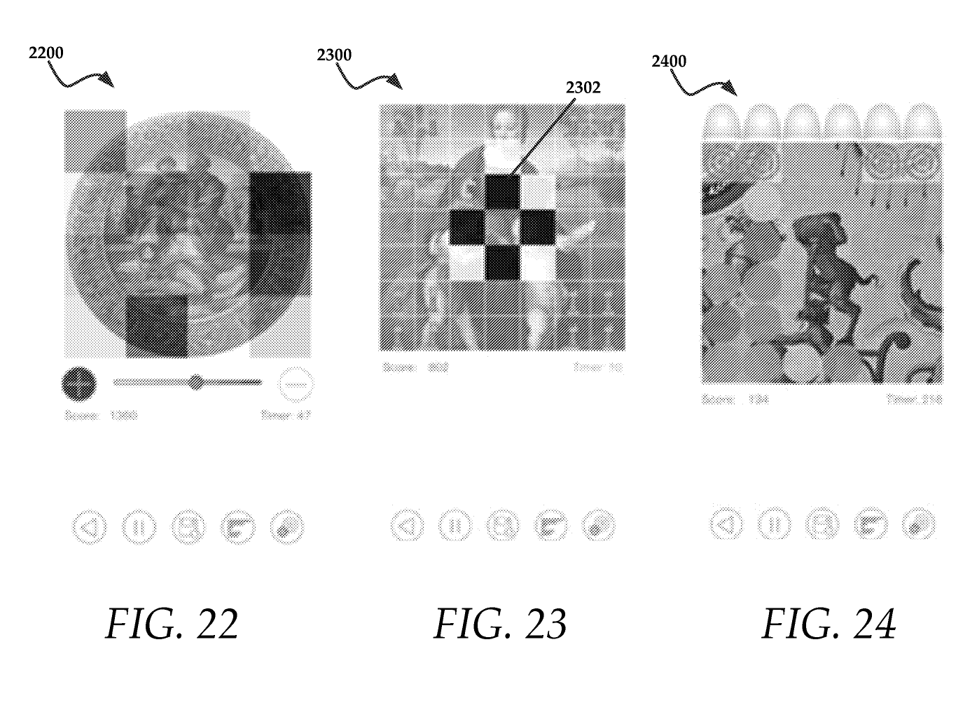

In FIG. 22, a game 2200 referred to as the color mosaic is illustrated. The user can tap on squares in order to make the nuances of color homogeneous. The squares change based on the number of touches. The bar below indicates the available number of shades. The user wins when all the squares have the same color and loses if the time expires.

FIG. 23 illustrates another example game 2300 referred to as the time map knight. In this game, the user must hit all the filled squares through the horse's L movement. If the user moves the horse in an area of game that does not have a square inside, a time counter starts. The counter resets to the maximum value if the user returns to a place that has a solid square. The user loses if the counter reaches zero or if the black enemies 2302 hit the user. The rules of the chess can apply in some embodiments. For example, a pawn moves forward to the unoccupied square immediately in front of it on the same file. A rook moves any number of squares along any rank or file. A knight moves two squares vertically and one square horizontally, or two squares horizontally and one square vertically (L movement). A bishop moves any number of squares diagonally and the queen moves one square in any direction. The king moves one square in any direction.

A discus stacking game 2400 is illustrated in FIG. 24. In this game, the user taps on one button at the top where a disc with a random color will be generated and located on the first available space at the bottom. The user moves the disc horizontally letting them get off from one column to another until the user achieves a column composed by three or four disks with the same color. Every time the user gets a column of three or four discs of the same color the user eliminates one or two targets placed at the top. The user completes the level if they eliminate all targets, and loses if the time expires or if the whole area is occupied by discs.

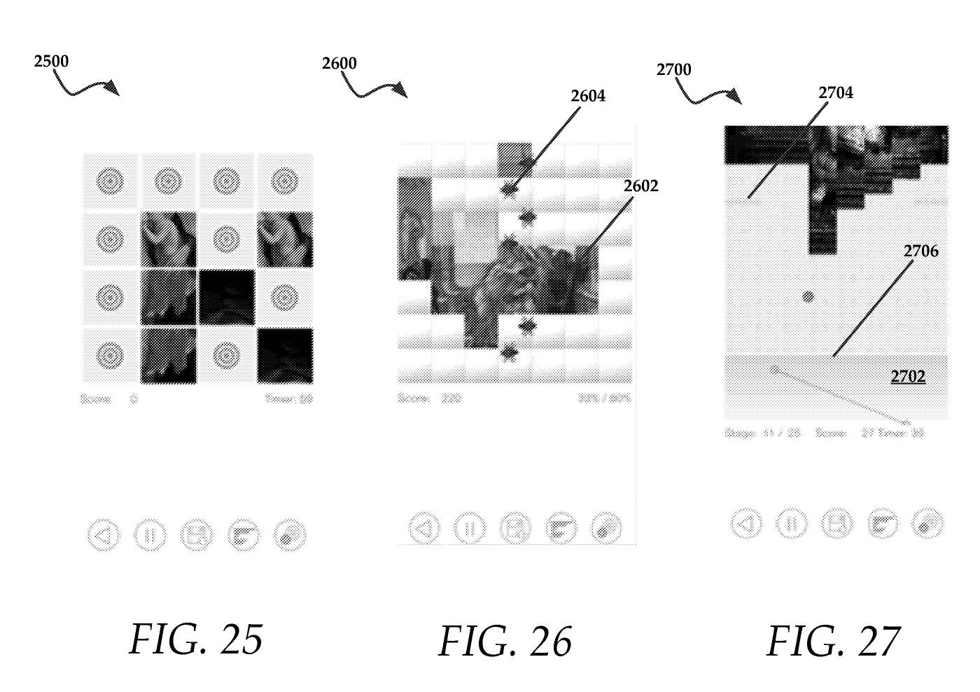

In another game referred to as equals joiner 2500, as illustrated in FIG. 25, the user is provided with five seconds in which to memorize the position of 16 cards. Each card has a twin. Cards must be matched before the time expires. For each correct matching earn a time bonus, for each error a mauls. The user loses if the time expires.

FIG. 26 illustrates another example game referred to as artwork cleaner 2600. The user moves their finger across the screen in order to reveal which artwork 6502 is hidden below. The user loses if they hit enemies 2604 that rotate on the playing area.

FIG. 27 illustrates another example game 2700 that is referred to as angle rebound. In this game a ball starts moving when the user touches the area at the bottom 2702. In order to let the ball bounce, the user draws a line in the area at the bottom and releases. The ball follows the angle drawn from the line. The user has 60 seconds to reach the score indicated in the bottom left. The user earns a point if they hit the low points of the opera and loses a point if the ball hits the yellow lines 2704 or bounces on the low edge 2706.

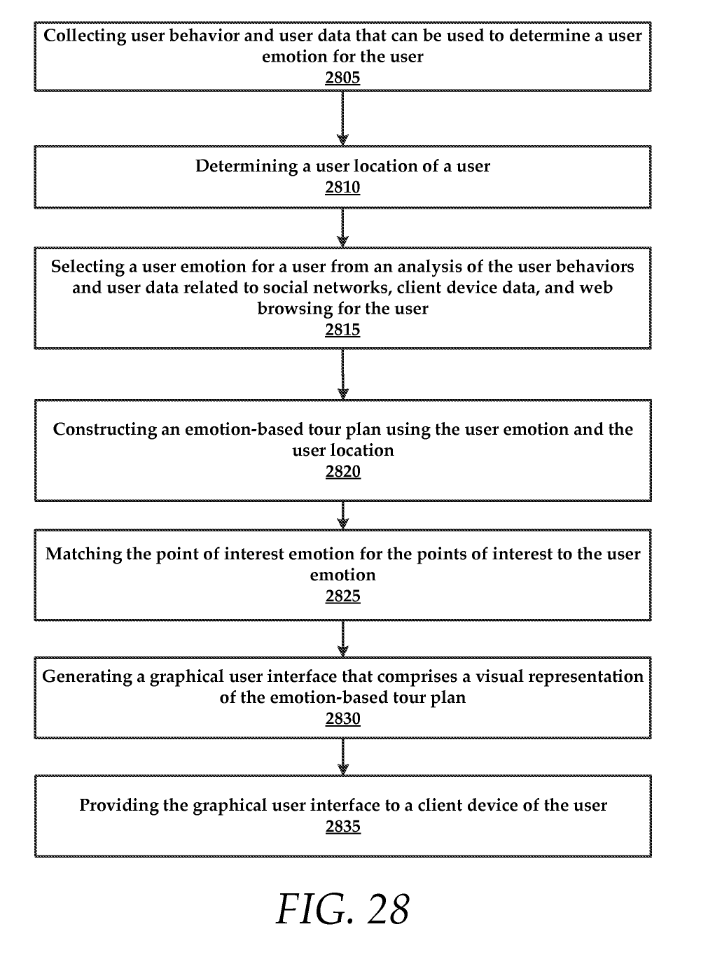

FIG. 28 is a flowchart of an example method of the present technology. In some embodiments, the method can include collecting 2805 user behavior and user data that can be used to determine a user emotion for the user. As mentioned above, this can include information obtained from social networks, client device data, and web browsing for the user. The method can also include determining 2810 a user location of a user. For example, the location of the user can be determined through selection of a location by the user or by determining location through the use of location or position information such as GPS data for the client device of the user.

In some embodiments, the method includes selecting 2815 a user emotion for a user from an analysis of the user behaviors and user data related to social networks, client device data, and web browsing for the user. Once an emotion has been selected for the user, the method includes constructing 2820 an emotion-based tour plan using the user emotion and the user location. To be sure, the user location comprises points of interest that are each associated with a description that is capable of being assigned a point of interest emotion.

In one embodiment, the points of interest are analyzed and categorized according to their emotion, prior to the user requesting the creation of an emotion-based tour plan.

In some embodiments, the points of interest are found proximate the user location and are matched to the user emotion by matching 2825 the point of interest emotion for the points of interest to the user emotion.

In accordance with the present technology, the method can include generating 2830 a graphical user interface that comprises a visual representation of the emotion-based tour plan as well as a step of providing 2835 the graphical user interface to a client device of the user.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the technology in the form disclosed. Many modifications and variations will be apparent to those of ordinary skill in the art without departing from the scope and spirit of the technology. Exemplary embodiments were chosen and described in order to best explain the principles of the present technology and its practical application, and to enable others of ordinary skill in the art to understand the technology for various embodiments with various modifications as are suited to the particular use contemplated.

Aspects of the present technology are described above with reference to flowchart illustrations and/or block diagrams of methods, apparatus (systems) and computer program products according to embodiments of the technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the present technology has been described in connection with a series of preferred embodiment, these descriptions are not intended to limit the scope of the technology to the particular forms set forth herein. It will be further understood that the methods of the technology are not necessarily limited to the discrete steps or the order of the steps described. To the contrary, the present descriptions are intended to cover such alternatives, modifications, and equivalents as may be included within the spirit and scope of the technology as defined by the appended claims and otherwise appreciated by one of ordinary skill in the art.

What is claimed is:

1. A method, comprising:
receiving at least a user emotion and a user location from a user;
constructing an emotion-based tour plan using the user emotion and the user location, wherein the user location comprises points of interest that are each associated with a description that is capable of being assigned a point of interest emotion, the points of interest being found proximate the user location and matched to the user emotion by matching the point of interest emotion for the points of interest; and
providing the emotion-based tour plan to the user via a client device.

2. The method according to claim 1, further comprising:
determining a mobility of the user, the mobility of the user being related to an ability of the user to move from between the points of interest; and
wherein the points of interest are selected from the user emotion, the location, the point of interest emotion, and the mobility of the user.

3. The method according to claim 1, further comprising:
receiving audio feedback or notes from the user regarding one or more of the points of interest; and
storing the audio feedback or notes in storage medium.

4. The method according to claim 1, wherein the location includes an art gallery and the points of interest include any of art objects, artwork, as well as other artistic points of interest.

5. The method according to claim 1, further comprising generating a map that illustrates an overview of the emotion-based tour plan.

6. The method according to claim 1, wherein the emotion-based tour plan comprises for each point of interest, a fact sheet or other descriptive information that instructs the user as to the details of each point of interest.

7. The method according to claim 1, further comprising:
determining presence of a friend to the user proximate the user location; and
mapping the friend on a map that displays the points of interest.

8. The method according to claim 1, further comprising providing one or more games or quizzes that are related to the points of interest.

9. A method, for generating a plurality of pre-defined emotion-based tour plans, the method comprising:
creating a plurality of points of interest, wherein the plurality of points of interest include an emotion and a location;
assembling the plurality of points of interest into the plurality of pre-defined emotion-based tour plans according to an emotion shared between the plurality of points of interest; and
selecting one or more of the plurality of pre-defined emotion-based tour plans for a user based on a user emotion determined for the user.

10. The method according to claim 9, further comprising storing the plurality of pre-defined emotion-based tour plans in a storage medium.

11. The method according to claim 9, wherein the plurality of pre-defined emotion-based tour plans are created for the same tour location.

12. The method according to claim 9, wherein creating a plurality of points of interest comprises:
receiving descriptive information for the plurality of points of interest;
determining an emotion of each of the plurality of points of interest from the descriptive information; and
assigning to each of the plurality of points of interest a determined emotion.

13. The method according to claim 9, further comprising:
receiving a user emotion from the user; and
selecting one or more of the plurality of pre-defined emotion-based tour plans for the user based on the received user emotion.

14. A method for providing a graphical user interface for displaying an emotion-based tour plan, the method comprising:
determining a user location of a user;
selecting a user emotion for a user from an analysis of user behaviors and user data related to social networks, client device data, and web browsing for the user;
constructing an emotion-based tour plan using the user emotion and the user location, wherein the user location comprises points of interest that are each associated with a description that is capable of being assigned a point of interest emotion, the points of interest being found proximate the user location and matched to the user emotion by matching the point of interest emotion for the points of interest;
generating a graphical user interface that comprises a visual representation of the emotion-based tour plan; and
providing the graphical user interface to a client device of the user.

15. The method according to claim 14, further comprising:
determining a mobility of the user, the mobility of the user being related to an ability of the user to move from between the points of interest; and
wherein the points of interest are selected from the user emotion, the location, the point of interest emotion, and the mobility of the user.

16. The method according to claim 14, further comprising:
receiving audio feedback or notes from the user regarding one or more of the points of interest; and
storing the audio feedback or notes in storage medium.

17. The method according to claim 14, wherein the location includes an art gallery and the points of interest include any of art objects, artwork, as well as other artistic points of interest.

18. The method according to claim 14, further comprising generating a map that illustrates an overview of the emotion-based tour plan.

19. The method according to claim 14, wherein the emotion-based tour plan comprises for each point of interest, a fact sheet or other descriptive information that instructs the user as to the details of each point of interest.

20. The method according to claim 14, further comprising:
determining presence of a friend to the user proximate the user location; and
mapping the friend on a map that displays the points of interest.
